(19) United States
(12) Patent Application Publication
(10) Pub. No.: US 2023/0018125 A1
(43) Pub. Date: Jan. 19, 2023

(54) Processing Multi-Horizon Forecasts For Time Series Data

(71) Applicant: Google LLC, Mountain View, CA (US)

(72) Inventors: Si Jie Bryan Lim, London (GB); Sercan Omer Arik, San Francisco, CA (US); Nicolas Loeff, Redwood City, CA (US); Tomas Pfister, Redwood Shores, CA (US)

(21) Appl. No.: 17/782,865

(22) PCT Filed: Nov. 25, 2020
(86) PCT No.: PCT/US2020/062130

§ 371 Date: Jun. 6, 2022

Related U.S. Application Data
(60) Provisional application No. 62/949,904, filed on Dec. 18, 2019.

(51) Int. Cl. G06N 3/08

(52) U.S. Cl. CPC G06N 3/08

(57) ABSTRACT

Methods, systems, and apparatus, including computer storage media, for performing multi-horizon forecasting on time-series data. A method includes determining short-term temporal characteristics for respective forecasting horizons of one or more time-steps. The determining can include generating, using RNN encoders, encoder vectors based on static covariates, and time-varying input data; and predicting using one or more RNN decoders, a short-term pattern for a respective future time period. The method can also include capturing long-term temporal characteristics for the respective forecasting horizons based on the static covariates, the time-varying input data captured during the respective past time-periods, and the time-varying known future input data.

### CROSS-REFERENCE TO RELATED APPLICATIONS

The present application claims the benefit of the filing date of U.S. Provisional Application No. 62/949,904, filed Dec. 18, 2019, entitled TEMPORAL FUSION TRANSFORMERS FOR INTERPRETABLE MULTI-HORIZON TIME SERIES FORECASTING, the disclosure of which is hereby incorporated herein by reference.

### BACKGROUND

Neural networks are machine learning models organized into two or more layers of smaller models (or “layers”) each configured to process one or more inputs and to generate one or more outputs. The inputs can come from a previous layer, somewhere external to the neural network, or both. Each layer can include one or more activation functions that can process incoming input with a weight value, and optionally, a bias. A neural network can be trained according to a learning algorithm to learn weight values that cause the neural network to generate accurate outputs for given inputs.

An encoder-decoder recurrent neural network (RNN) is a type of neural network architecture that can be trained to identify patterns between an input sequence and an output sequence of data, by converting the input sequence into a fixed-form representation. Then, a second model (the “decoder”) receives the encoded sequence as input, and decodes the encoded sequence to generate a predicted sequence, e.g., a sentence in English translated from the sentence in French.

An encoder-decoder long short-term memory (LSTM) network is a type of encoder-decoder RNN that employs LSTM networks as the encoder and decoder models. An LSTM network includes one or more cell states, input gates, and forget gates. The cell states store information that the LSTM network is said to “remember” from processing data at previous time-steps, while the gates regulate what information the LSTM network obtains or discards from the cell state and for a given time-step.

Horizon forecasting refers to the prediction of different variables at a given time-step or time-steps (a “forecasting horizon”). Multi-horizon forecasting refers to prediction of different variables for more than one horizon.

### SUMMARY

This specification describes technologies for processing time-series data to generate multi-horizon forecasts. These technologies generally involve a system that processes both short- and long-term temporal characteristics from time-series data. The temporal characteristics can be augmented with static metadata corresponding to time-independent variables of the time-series data. By processing time-dependent data with corresponding time-independent data, a system implemented in accordance with the description of this specification can generate accurate and interpretable forecasts at different time-steps or groups of time-steps (“forecasting horizons”).

A system as described in this specification in some implementations can selectively filter out or gate some input at different time-steps, while assigning weights of relative importance to other input. In doing so, input data can be processed with higher granularity by the system, consistent with the highly variable nature of time-series data.

Multi-horizon forecasting as described in this specification can be beneficial in a number of applications in which characteristics of entities represented in time-series data can vary over time.

As an example, the entity can be a power grid and characteristics can include consumption of the grid at different locations and different points in time. The system in some implementations can predict a future rate of electricity consumption at different forecasting horizons. The predicted future rate of electricity consumption can be used to anticipate shifts in power grid load, and an automated system can evaluate the power grid against the predicted future rate of consumption to determine at which locations infrastructure for the power grid needs to be improved or replaced.

As another example, the entity can be a highway traffic system, defined by a number of different interconnecting roads and highways. Characteristics for the highway traffic system can include a flow of traffic, and/or traffic congestion at different points of time and at different locations. In some implementations, the system can predict future traffic patterns at different forecasting horizons. The predicted traffic patterns can be used, for example, as part of causing automated traffic signals and other traffic-control mechanisms to perform according to different schedules for improving traffic flow and/or for reducing congestion.

As another example, if the entity represented is a commercial retailer, characteristics can include the change in inventory over a period of time, such as over a year or during the holiday season. Other characteristics can include seasonal changes in cost for different items in inventory, and the rate at which some products are sold over others of a similar type, such as electronics. In some implementations, the system can forecast the expected variation of inventory at different forecasting horizons. An automatic inventory control system can adjust how different items in inventory are purchased, for example by purchasing when supply is higher at an earlier time in anticipation of time in which the inventory is predicted to be low but corresponding supply is also low.

As another example, if the entity represented is a medical treatment facility, characteristics can include admission rate of walk-in patients or the rate at which patients are discharged. Characteristics can also include different medical conditions for patients treated at the medical treatment facility, including characteristics measured in the aggregate, such as types of conditions that are common across patients, and the average time for their recovery from those types of conditions. In some implementations, the system can forecast the expected admission of future patients at different forecasting horizons. In response to the expected admission of future patients, an automated system can prepare for necessary arrangements, such as by the acquisition of additional medical equipment and/or scheduling of additional personnel at the facility.

As another example, characteristics can also include characteristics varying over time and related to the financial or economic condition of the entity. Characteristics of this type can include daily or weekly revenue for the entity over a period of time. Characteristics can also include short- or long-term patterns, such as short- or long-term changes to revenue when measured hourly and daily versus monthly or yearly. In some implementations, the system can forecast the expected variation revenue at different forecasting horizons.

The forecasted outputs can depend on complex relationships between many static and time-varying covariates. For example, commercial retailers may look at increasing or decreasing their available inventory based on how consumer demand increases or decreases at different times of the year. As another example, a patient treatment plan can be generated and adjusted over the course of a period of time for treatment, adjusting for changes in the patient's health in response to the treatment plan or based on other characteristics such as pre-existing conditions.

In addition to the implementations of the attached claims and the implementations described above, the following implementations are also innovative.

A system can include a sequence-to-sequence layer and a temporal self-attention layer for determining short- and long-term temporal characteristics for respective forecasting horizons of one or more time-steps. The sequence-to-sequence layer can be implemented by one or more computers, and configured to determine short-term temporal characteristics for the respective forecasting horizons of one or more time-steps. The sequence-to-sequence layer can include one or more recurrent neural network (RNN) encoders for generating encoder vectors based on static covariates and time-varying input data captured during respective past time-periods, and one or more RNN decoders, each RNN decoder configured to predict a short-term pattern for a respective future time period based on the encoder vectors, the static covariates, and time-varying known future input data. The temporal self-attention layer can be implemented by the one or more computers and configured to capture long-term temporal characteristics for the respective forecasting horizons. The temporal self-attention layer can include a multi-head attention layer configured to generate a forecast for each horizon based on the static covariates, the time-varying input data captured during the respective past time-periods, and the time-varying known future input data.

The system can further include a variable selection layer, the variable selection layer can be configured to generate variable selection weights to each input variable including one or more of the static covariates, the time-varying input data captured during respective past time-periods, or the time-varying known future input data.

The variable selection layer can include a plurality of variable selectors, with each variable selector of the plurality of variable selectors being configured to generate variable selection weights for the input variables at a respective future or past time period.

The variable selection layer can include a variable selector configured to generate variable selection weights for a selection of the static covariates.

The system can further include one or more static covariate encoders configured to encode context vectors based on the variable selection weights for the selection of the static covariates.

The encoded context vectors can be passed to each of the plurality of variable selectors in the variable selection layer.

The encoded context vectors can be passed to a static enrichment layer, the static enrichment layer can include a plurality of gated residual networks (GRNs). Each GRN can be assigned a respective future or past time period and each GRN can be configured to increase the weight of static covariates within the encoded context vectors that influence temporal dynamics corresponding to its respective time period.

The output of each GRN in the static enrichment layer can form the dataset inputted into the multi-head attention layer.

The output of each GRN can be input into a respective mask of the multi-head attention layer, wherein each mask corresponds to a respective time period for causal prediction.

The forecast for each future time period can be transformed into a quantile forecast.

The system can further include a plurality of gating networks, wherein each gating network includes a plurality of gated linear units (GLUs) with shared weights.

The plurality of GLUs can be configured to reduce contributions of variables that have less effect on output prediction of the multi-horizon forecasting.

Other implementations of the foregoing aspect can include a computer-implemented method, an apparatus, and computer programs recorded on one or more computer-readable storage media.

The subject matter described in this specification can be implemented so as to realize one or more of the following advantages or technical effects. Multi-horizon forecasting of time-series data can be generated with higher accuracy for heterogeneous inputs across a plurality of time-steps. From data characterizing time-independent and time-dependent features of different entities, the most relevant features for forecasting can be selected over less relevant features. The automatic selection of relevant features can vary depending on different forecasting horizons-of-interest and differences between sets of time-series data processed. In addition and advantageously, the system does not neglect or generalize time-independent static covariates that affect input data at different time-steps in time-series data.

The system can automatically interpret the relative importance of certain input variables to a predicted forecast, and gate portions of the system from processing input data when the system determines the relative importance of characteristics generated by those gated portions to be low. The learned importance of the input variables can be used to improve the accuracy of future forecasting, for example because the importance can be used to engineer and/or select features from input data that are found to be more relevant based on the importance assigned to input variables previously and with those same features.

For example, the system can discriminate between time-series data having or not having significant long-term temporal patterns across a period of time, and automatically gate out portions of the system dedicated to long-term temporal characteristic processing.

Long-term temporal patterns can include patterns of characteristics observed across an entire analyzed time-window. A time-window as described herein refers to the period in the past and in the future from which the system can analyze data to generate a forecast. Long-term temporal patterns can include patterns in revenue for an entity on a yearly basis. As another example, a long-term temporal pattern for a medical treatment facility can relate to seasonal spikes or dips in admissions of patients for certain medical conditions at different times of the observed time-window. The observed time-window can span months or years to increase the range from which the system can identify long-term temporal patterns.

Short-term patterns, as described herein in this disclosure, can be patterns within a predetermined distance relative to a current time-step whose data is processed by the system. For example, the system can generate short-term patterns from data near-in-time to a currently processed time-step. If the time-series data specifies daily data corresponding to an entity, then as an example the system can generate short-term patterns that appear daily or weekly within the time-series data. For example, a short-term pattern can include daily fluctuations for patient admissions for a medical treatment facility, such as morning admissions versus nightly admissions.

The system can identify short-term patterns in events related in-time to each other. For example, a short-term pattern can characterize a correlation between two events. If the entity is a commercial retailer, for example, then a short-term pattern can be the purchase and subsequent return of certain types of products sold, measured over a short period of time relative to the entire observed time-window.

On the other hand, the system can weight more heavily other short- or long-term characteristics that the system determines to be more relevant during operation to generate forecasts, and can suppress other characteristics that are less relevant or not relevant at all. The adaptability of the system can help mitigate overfitting to highly-dimensional data, while still allowing for highly accurate forecasting through techniques that are generalizable for different sources of time-series data.

The system can jointly generate characteristics for input at a given time-step from surrounding input that is either temporally near, e.g., a neighboring time-step, or far, e.g., within an analyzed time-window, relative to the given time-step. By generating the different characteristics jointly, the system can avoid or mitigate error propagation that can occur in approaches in which the short-term and long-term characteristics are generated sequentially.

Implementation of the techniques described in this specification can also allow for more intuitive and less complicated models, which can allow for better explainability and less “black box” processing. Outputs of the system can be analyzed more efficiently, at least because the system can provide insights into relevant input at different time-steps while also distinguishing the importance of different characteristics present at those time-steps. The proposed system can result in better analysis of resulting forecasts over post hoc approaches on black box models.

The system can provide more accurate data describing the relative importance of different characteristics for generating a forecast. For example, the system can identify (i) globally-important variables, (ii) persistent temporal patterns, and (iii) significant events, such as deviations from temporal patterns. These insights can be generated on a per-sample or global basis, meaning that the interpretability of the forecasts can be more accurate and clear whether examined on a per-horizon basis, or across all of the horizons forecasted. In providing easily interpretable data with strong causal connections to predicted forecasts, the system can automatically adapt to perform more accurately and with fewer operations for a given prediction problem and time-series data, e.g., by learning variable importance and/or by gating portions of the system as described above.

### BRIEF DESCRIPTION OF THE DRAWINGS

FIG. 1 is a functional diagram of an example of a multi-horizon forecasting system.

FIG. 2 is a functional diagram of the system shown in FIG. 1 and shows components of the sequence processing layer and the remote dependency layer according to some aspects of the disclosure.

FIG. 3 is a flowchart of an example of a process for multi-horizon forecasting.

FIG. 4 is a functional diagram of an example of a Gated Residual Network (GRN).

FIG. 5 is a functional diagram of an example of a variable selector.

FIG. 6A is a flowchart of an example of a process for determining variable importance for forecasted time-series data.

FIG. 6B is a flowchart of an example of a process for determining persistent temporal patterns for forecasted time-series data.

FIG. 6C is a flowchart of an example of a process for determining shifts in temporal behavior in time-series data.

FIGS. 7A and 7B show an example of a multi-horizon forecasting system implemented on or more computing devices.

Like reference numbers in the drawings above indicate like elements.

### DETAILED DESCRIPTION

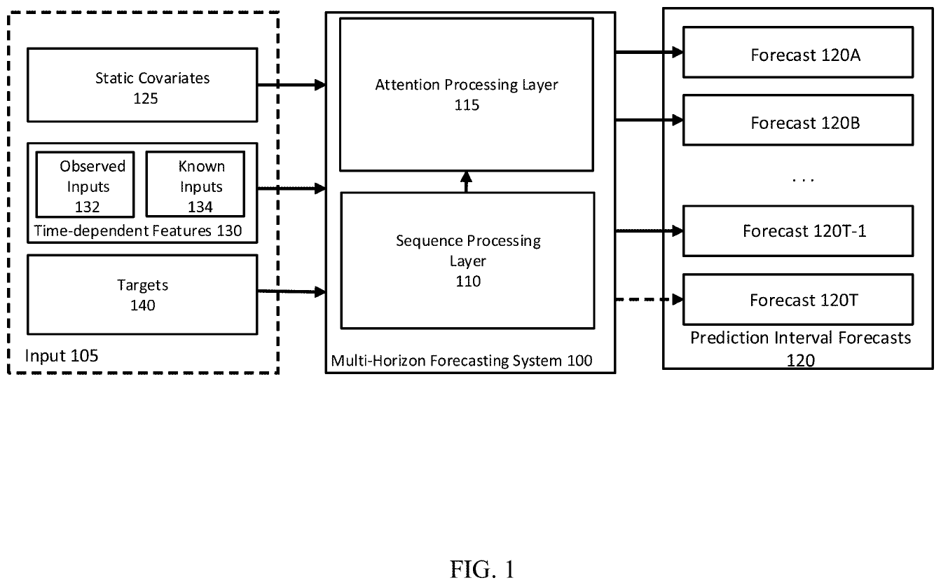

FIG. 1 is a functional diagram of an example of a multi-horizon forecasting system 100. The system 100 is configured to obtain input 105 and to generate forecasts 120 for different variables at different forecasting horizons. The system 100 can obtain the input 105 from a time-series database, or any source of time-series data. The input 105 includes different variables that each correspond to at least one entity represented through the time-series data. Specifically, the input 105 includes static covariates 125, time-dependent features 130, and targets 140 that each at least partially represent one or more entities.

An entity can be represented at least partially through one or more static covariates. Static covariates are variables that are time-independent, i.e., do not vary in time from time-step to time-step. Time-dependent features 130, on the other hand, are variables that do vary with time, i.e., from time-step to time-step. Time-dependent features include observed inputs 132 and known inputs 134 for a given time-step. The observed inputs 132 are variables that are measured at or before a time-step t, and the known inputs 134 are variables that vary for different time-steps after a time-step t, but that are known in advance. For example, if time-steps are measured in days, then an observed input for day t and for an entity retail store i can be revenue for the store on day t, and a known input can be the day of the week or calendar date on day t.

As another example, an observed input can include a traffic delay measured in minutes at a particular location and time of a highway traffic system, and a known input can include times at which sections of road of the highway traffic system are closed for construction at various times within the observed time-window.

As another example, an observed input can include electricity consumption during a particular day for an electric power grid, or the average temperature on the particular day. A known input for the electric power grid can be a planned maintenance schedule for repairing or maintaining certain sections of the power grid.

In this specification, prediction interval forecasts 120 refer to the prediction of values of variables at different time-steps of interest (or, “forecasting horizons”). For example, given time-series data for customers and their spending behavior, the system 100 can generate forecasts 120A-T predicting sales revenue (a variable of interest) at different forecasting horizons A-T. The horizons for which the forecasts 120A-T correspond to can be predetermined, or can be specified as part of the input 105.

The system 100 is configured to process heterogeneous time-series data. This means that the system 100 does not assume the presence of a particular type of input, e.g., certain time-dependent or time-independent variables for a given entity at a given time-step. If there are missing static covariates for an entity, or if there are missing known or observed variables for an entity at a given time-step t, the system 100 can process the inputs available to generate temporal characteristics corresponding to the time-step. The system 100 is configured to integrate available static covariates representing an entity with the processing of corresponding time-dependent features. This integration can result in more efficient and accurate forecasts over conventional techniques that either make limiting assumptions about the format or nature of input variables, or outright ignore time-independent variables during forecasting.

To generate temporal characteristics relating to a time-step and entities whose features are represented by input data corresponding to the time-step, the system 100 is configured to implement a sequence processing layer 110 and a remote dependency layer 115. The combination of these two layers 110, 115 can allow the system 100 to learn both long- and short-term temporal characteristics from both the static covariates 125 and the time-dependent features 130.

Short-term temporal characteristics can include characteristics generated from input at neighboring time-steps relative to a currently processed time-step t, e.g., t+1, t−1. The sequence processing layer 110 can generate the short-term temporal characteristics using a sequence-to-sequence layer 220, described below.

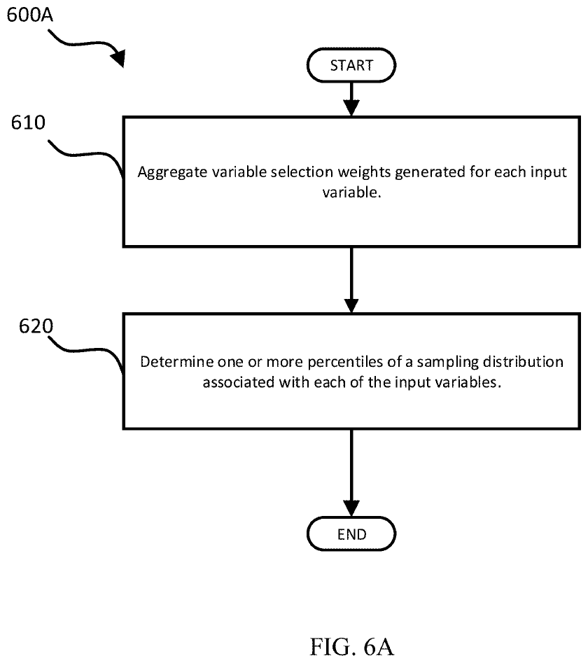

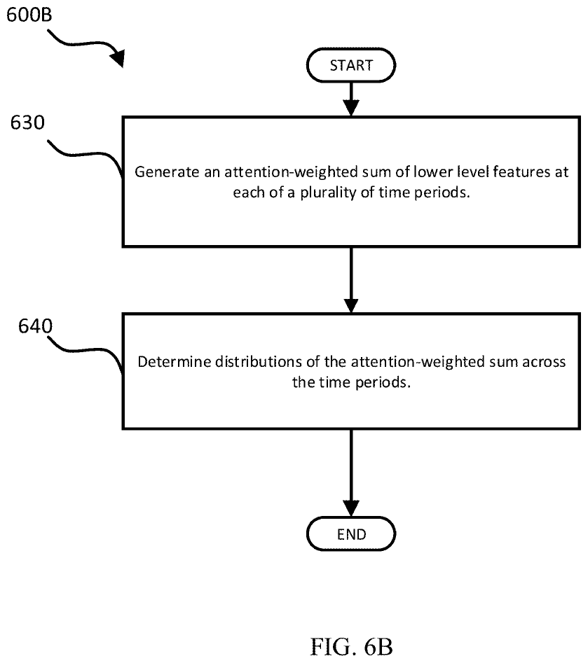

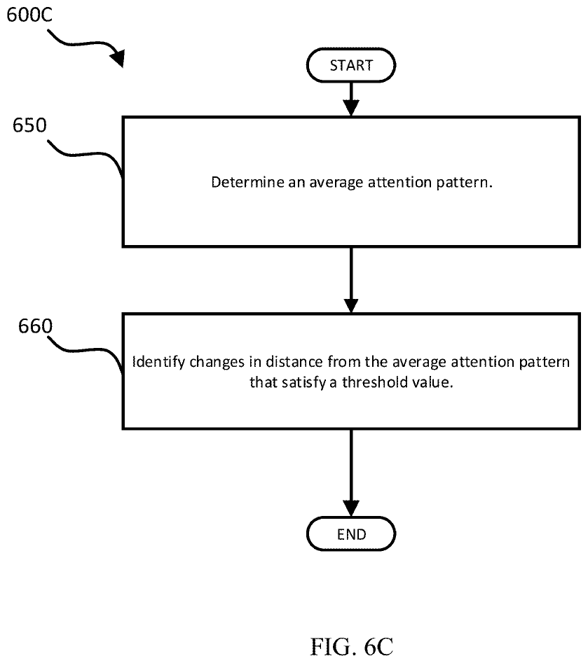

The temporal characteristics can include the relative importance of an input variable to predicting a forecast for a given forecasting horizon. As another example, the temporal characteristics can represent temporal patterns over a short (time-step to time-step) or long (e.g., over tens or hundreds of time-steps) period of time. In addition, the system 100 can generate temporal characteristics that represent deviations from identified temporal patterns, as well as other types of significant events described in more detail below with reference to FIGS. 6A-C.

In general, the sequence processing layer 110 is configured to receive the input 105 and to generate temporal characteristics of the input 105 that are relevant to generating the forecasts 120. The attention processing layer 115 is configured to obtain the temporal characteristics from the sequence processing layer 110 and the static covariates 125, and to generate the forecasts 120.

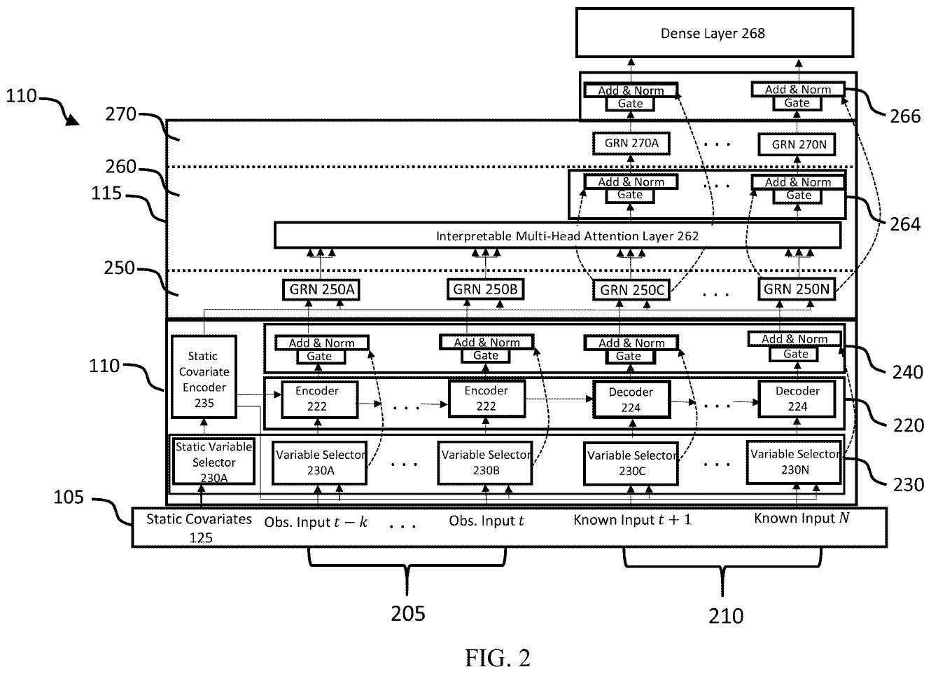

As described in more detail below with respect to FIGS. 2-5, the system 100 intertwines the static covariates 125 across the processing of the input 105 through the layers 110, 115, which can result in more efficient and accurate forecasts at least because static covariates are not ignored or treated in isolation. For example, the attention processing layer 115 can enrich temporal characteristics from the sequence processing layer 110 with the static covariates 125 to further identify characteristics of the input 105 that may otherwise be missed if time-dependent and time-independent data were processed in isolation. The attention processing layer 115 is also configured to generate additional short-term or long-term temporal characteristics—or augment existing temporal characteristics—according to identified long-term temporal patterns and significant events such as deviations from the temporal patterns.

The system 100 can generate the prediction interval forecasts 120 via multiple quantiles of likely target values for each forecasting horizon. For example, the system 100 can generate forecast 120A to represent the 10^{th}, 50^{th}, and 90^{th} quantile of predicted values within a target and at a particular forecasting horizon A, where the 50^{th} quantile would correspond to the point forecast. For T forecasting horizons, the system 100 can generate forecasts 120A-T, each forecast corresponding to respective one or more time-steps from A to T. The specific quantile cut points that are used to generate the forecasts 120 can be predetermined, or the system 100 can receive one or more quantile cut points as part of the input 105 (not shown in FIG. 1).

The system 100 can receive targets 140 as part of the input 105. For purposes of description in this specification, it is assumed that the system 100 generates the forecasts 120 as one or more quantiles of predicted values for each forecasting horizon, but it is understood that, in some implementations, the system 100 generates the forecasts 120 point-wise, e.g., as some or all of the predicted variables for a forecasting horizon generated from the input 105 directly.

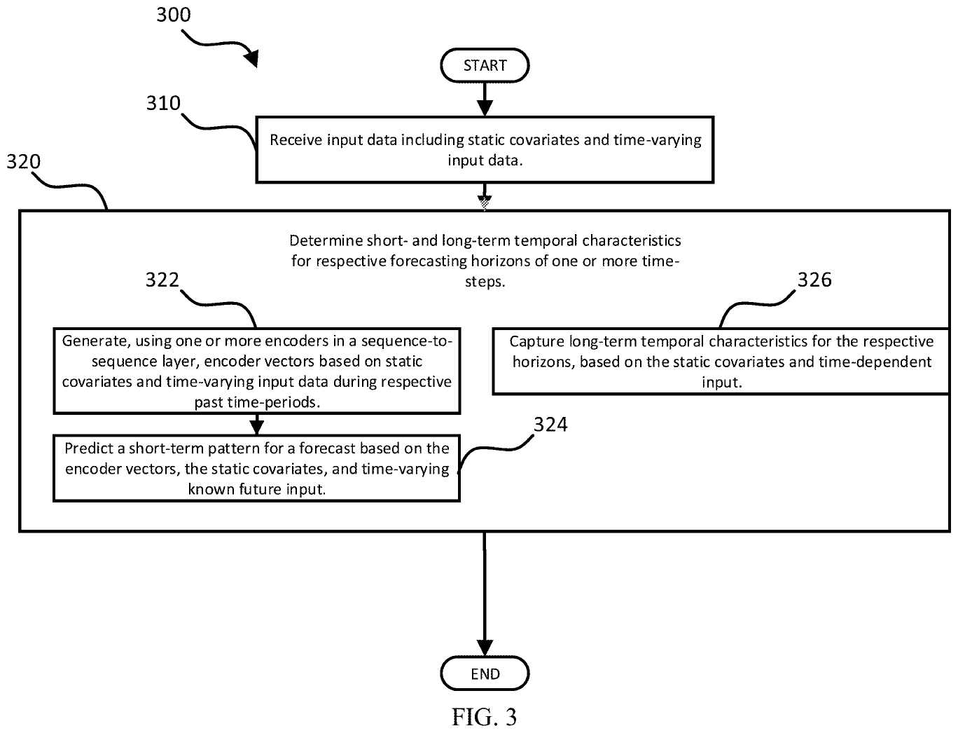

FIG. 2 is a functional diagram of the system 100 shown in FIG. 1 and shows components of the sequence processing layer 110 and the attention processing layer 115 according to some aspects of the disclosure. For ease of description reference will occasionally be made to a time-step t, but it is understood that the system 100 is configured to process, e.g., in parallel or in sequence, input across a plurality of time-steps to generate corresponding forecasts. Example implementations of the system 100 are described, below, in reference to FIGS. 2-8, and an example process for multi-horizon forecasting that the system 100 can be configured to perform is described below in reference to FIG. 3.

FIG. 3 is a flowchart of an example of a process 300 for multi-horizon forecasting. For convenience, the process 300 is described as performed by a system implemented on one or more computers, located in one or more locations, and programmed appropriately in accordance with this specification. For example, a multi-horizon forecasting system, e.g., the multi-horizon forecasting system 100 of FIGS. 1-2, appropriately configured, can perform the process 300.

The system receives 310 input data. Referring to FIG. 2, the system 100 can receive the input 105 as a subset of observed inputs 205 in the range [t−k, t], where t is a current time-step being processed, and k is a look-behind parameter indicating that the system 100 will process observed variables from the current time-step to the (t−k)^{th} time-step. k can be any integer value in the range [0, t], where a value of 0 for k corresponds to the system 100 processing only the observed variables from the current time-step t, and a value of t for k corresponds to the system 100 processing every observed variable beginning from the first time-step. The system 100 processes observational inputs for past time-periods within [−k, t] and in the past relative to the time-step t. Past time-periods can be of one or more time-steps.

The system 100 can also receive a subset of known inputs 210 in the range [t+1, τ_{MAX}]·τ_{MAX} is a look-forward parameter indicating that the system 100 will process known variables for future time-steps t+1 to the Nth time-step, where N=k+τ_{MAX}. The system can process known inputs for future time-periods within [t+1, τ_{MAX}]. Future time-periods can be of one or more time-steps.

Together, [k, τ_{MAX}] define a time-window for which the system 100 processes known and observational input relative to a current time-step t. The length of the range [k, τ_{MAX}] is referred to in this specification as N, e.g., known input N representing the known input for the time-step farthest ahead of the current time-step t in the time-window. Both k and τ_{MAX} are parameters that can be adjusted from implementation-to-implementation, and can also be different as between time-step to time-step. For example, the system 100 may process earlier time-steps according to a smaller time-window, and later time-steps according to a larger time-window. In some implementations, the system 100 is configured to receive and process the input 105 for a plurality of different time-windows defined by the look-behind and look-ahead parameters. The system 100 processes time-series data for a variety of different time-windows, and is configured to receive a predetermined range defining a time-window.

For time-steps where there are no known input and/or observed input, the system 100 can assign a constant value, e.g., 0. As described above with reference to FIG. 1, the static covariates 125 can also form part of the received input to the system 100.

Referring to FIG. 3, the system determines 320 short-term and long-term temporal characteristics for respective forecasting horizons of one or more time-steps. To do so, the system 100 can process the input 105 through the sequence processing layer 110 and the attention processing layer 115, jointly. In other words, by processing through both layers 110, 115, the system 100 can generate short-term and long-term characteristics that can be enriched or augmented by the respective short-term and long-term identification capability of both layers 110, 115, as described in more detail, below. As shown in FIG. 2, the sequence processing layer 110 includes a sequence-to-sequence layer 220, a static covariate encoder 235, and in some implementations, a variable selection layer 230.

Referring to FIG. 3, the determining 320 can include generating 322, using one or more encoders in the sequence-to-sequence layer 220, encoder vectors based on static covariates and time-varying input data captured during respective past time-periods. Time varying input data includes the observational inputs 205. Encoder vectors are encoded representations of the combination of at least the static covariates 125 and the observed input 205, the processing of which is described below. An encoded vector refers to a vector (or in some implementations, a multi-dimensional array or tensor) storing a representation of input data in a format the sequence processing layer 110 and/or the attention processing layer 115 is configured to receive. The encoding can be an automatic mapping from raw input data to a formatted representation suitable for processing. Encoding can also be performed, as described below, as part of generating an intermediate representation in performing sequence-to-sequence processing between an encoder 222 and a decoder 224.

Input to the sequence-to-sequence layer 220 that generates the encoder vectors is described, beginning with the static covariate encoder 235. The system 100 is configured to process the static covariates 125 through the static covariate encoder 235. In general, the static covariate encoder 235 is configured to generate context vectors which are encoded representations of the static covariates 125. The context vectors, indicated in this specification by C_{identifier}, are processed as part of input for both the sequence processing layer 110 and the remote processing layer 115. The static covariate encoder 235 can generate different context vectors based on a requirement for formatting of input to the various components of the system 100. In this way, the static covariate encoder 235 can more easily adapt to different input requirements as opposed to requiring a uniform input across different components of the system 100, e.g., across both the sequence processing layer 110 and the attention processing layer 115.

By integrating the context vectors in the manner described in this specification, the system 100 can condition temporal characteristics of the time-dependent input 205, 210 with time-independent data represented by the static covariates 125.

In time-series data, points or periods of significance are often identified in relation to values of variables representing other points near-in-time. These points of significance can include anomalies, change-points or cyclical patterns that can be important for the system 100 to identify to generate more accurate forecasts. In some cases, however, the inclusion of observed inputs can make detection of these significant points more difficult, as the number of observational inputs to known inputs may vary.

Therefore, the sequence-to-sequence layer 220 can include the encoder 222 and the decoder 224 that are separately configured to process observational and known inputs, respectively. The sequence-to-sequence layer 220 can generate short-term temporal characteristics, which can serve as part of the input to the remote processing layer 115.

The sequence-to-sequence layer 220 includes the encoder 222 and the decoder 224, both shown in an un-rolled representation spanning the time-window defined by the look-behind parameter k and look-ahead parameter τ_{MAX.} In general, the sequence-to-sequence layer 220 can be implemented according to any seq2seq machine learning technique. The encoder-decoder 222, 224 can be implemented according to any conventional technique for sequence to sequence models using Recurrent Neural Networks (“RNNs”), e.g., Long Short-Term Memory (“LSTM”) networks.

However the layer 220 is configured from implementation-to-implementation, the sequence-to-sequence layer 220 can process input from both the observed input 205, the known input 210, as well as context vectors encoded by the static covariate encoder 235.

The encoder 222 can include a plurality of layers, including an input layer that is configured to receive a past observational input and the context vectors; one or more hidden layers; and an output layer that propagates a hidden state for the processed data. The encoder 222 is configured to initially receive context vectors c_{c} and cₕ generated by the static covariate encoder 235. The context vector c_{c} initializes the cell state for the encoder 222 at time-step t−k, while the context vector cₕ initializes the hidden state for the encoder 222.

The encoder 222 is configured to receive, at each time-step in the range [t−k, t] the context vectors c_{c} and cₕ and a respective observed input for each time-step being processed between [t−k, t]. At time-step t, the encoder 222 propagates an encoded sequence forward to the decoder 224. The decoder 224 at time-step t+1 receives the encoded sequence generated by the encoder 222, and afterwards, processes the previous output from the decoder 224 at each time-step from t+1 to t+τ_{MAX}. Also at each time-step, the decoder 224 processes a respective known input for each time-step being processed between [t+1, τ_{MAX}].

Returning to FIG. 3, the system 100 predicts 324 a short-term pattern for a respective forecasting horizon based on the encoder vectors, the static covariates, and time-varying known future input. The output from the encoder 222 and the decoder 224 across each time-step forms a set of temporal characteristics that can represent a short-term pattern within the time-window analyzed. The temporal characteristics are denoted as:

ϕ(t,n)∈(ϕ)(t,−k), . . . ,ϕ(t,τ_{MAX}))

where n is a position index in the range of the time-window between the look-behind parameter k and the look-ahead parameter τ_{MAX}.

The position index n serves as a replacement for standard positional encoding (as is often used in sequence processing), providing an appropriate inductive bias for the time-ordering of the inputs. Altogether, the temporal characteristics ϕ(t, n) can include data from the context vectors encoding the static covariates 125, the observational inputs 205, and the known inputs 210. The attention processing layer 115 receives the temporal characteristics representing the short-term pattern identified in the time-window at each time-step, as the sequence-to-sequence layer 220 processes the input. In this way, the temporal features can capture relationships between the time-dependent and time-independent inputs that can fully use the heterogeneous nature of time-series data.

Also at each time-step, the encoder 222 and the decoder 224 additionally pass output, e.g., intermediate encoded/decoded representation generated while performing the encoding/decoding, from each time-step through a gating layer 240 of gates and normalization layers. An example configuration of the gating layer 240 is shown, below:

\tilde{ϕ}(t,n)=LayerNorm(\check{ξ}ₜ₊ₙ+GLU_{\tilde{ϕ}}(ϕ(t,n)))

where θ(t, n) is the output from the encoder 222 or decoder 224 at time-step n∈[−k, τ_{MAX}], LayerNorm is a layer normalization function, i.e., a function that normalizes a given input to a particular range, e.g., [0,1], \tilde{ξ}ₜ₊ₙ, is observational input or known input at time-step n, and GLU_{\tilde{θ}} is a gated liner unit applied to the output of the gating layer 240 to allow the system 100 to control the extent in which output from the encoder, decoder 222, 224 contributes to the output of the gating layer 240.

The intermediate encoded/decoded representation can be a vector or multi-dimensional array of values generated by the encoder/decoder 222, 224, and can represent output generated by activation functions of the encoder/decoder 222, 224. The intermediate encoded/decoded representation can vary as a function of the weights of the encoder/decoder 222, 224, as well as the input to the encoder/decoder 222, 224 at one or more previous time-steps. The input at the previous time-step(s) can itself be a function of an intermediate encoded/decoded representation generated by the encoder/decoder 222, 224 at the previous time-step(s).

A gated linear unit is a type of gating mechanism for gating at least a portion of a neural network. More detail regarding gated linear units can be found in Dauphin, et al., Language Modeling with Gated Convolutional Neural Networks, Proceedings of the 34^{th} Int. Conf. on Machine Learning (Sep. 8, 2017). The parameter \tilde{ϕ}; as in GLU_{\tilde{ϕ}} refers to trained weights for processing output from the sequence-to-sequence layer 220 to determine which output is gated. and which is not. The weights can be shared for each time-step, although in some implementations the GLU can be trained for specific time ranges within the analyzed time-window. Depending on the weights of the GLU across the gating layer 240, the layer 240 can potentially skip over a particular output if necessary to suppress the non-linear contribution of the particular output for subsequent processing. The system 100 may be trained to prioritize certain inputs that are measured to be more important than others at certain time-steps for generating a forecast.

Although represented as a GLU, in some implementations the system 100 uses other gating mechanisms as part of the gating layer 240. In some implementations, the GLU in the example configuration above is replaced with a linear layer, followed by an Exponential Linear Unit activation function (“ELU”), although other activation functions and gating mechanisms can be employed.

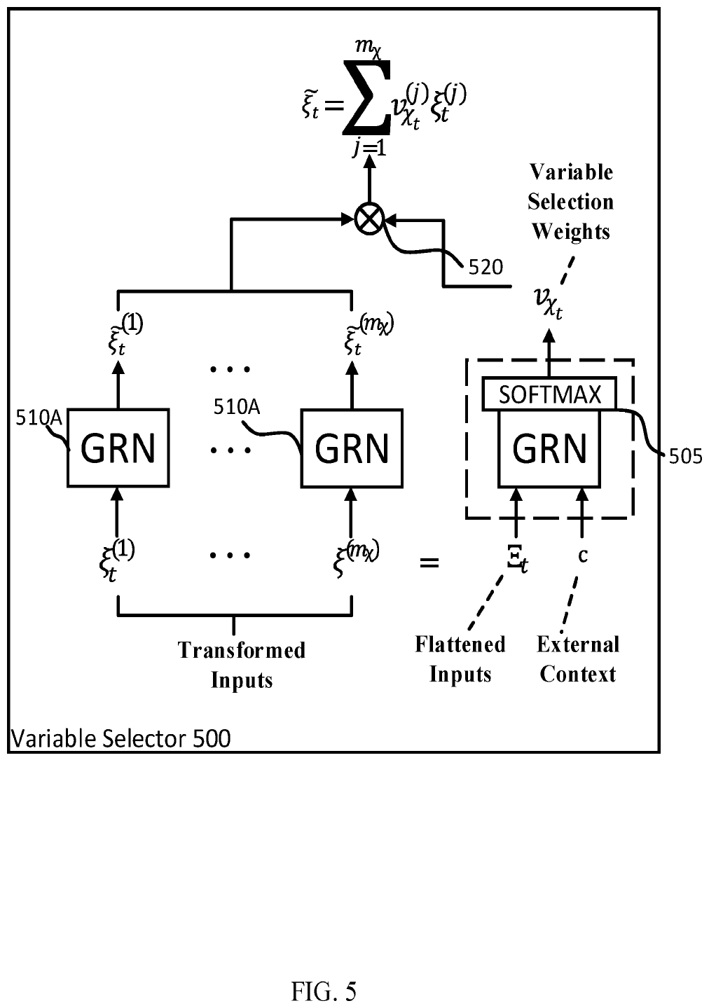

The system 100 can process the observational inputs 205 and the known inputs 210 through the sequence-to-sequence layer 220, after the system 100 processes the inputs 205, 210 through a variable selection layer 230. As described in more detail, below with reference to FIG. 5, the variable selection layer 230 can weigh different variables of the input 105 according to a learned measure of relevance, for example based on correlations between the presence or absence of input variables and the value of a corresponding forecast. In some implementations, the sequence-to-sequence layer 220 can process the inputs 205, 210 directly and without the variable selection layer 230.

The output of the gating layer 240 is passed as input to the attention processing layer 115. Although depicted as a separate layer in FIG. 2, in some implementations the gating layer 240 forms part of the sequence-to-sequence layer 220. In some implementations, the gating layer 240 is omitted altogether, and output from the encoder 222 is processed directly by the attention processing layer 115.

Referring back to FIG. 3, the system 100 captures 326 long-term temporal characteristics for a forecasting horizon, based on the static covariates and time-dependent input, i.e., observational inputs and known inputs within a time-window. In FIG. 2, the attention processing layer 115 is at least partially responsible for learning long-term temporal characteristics of the input 105 to the system 100, and is divided into at least three components: a static enrichment layer 250, a temporal self-attention layer 260, and a position-wise feed-forward layer 270. The attention processing layer 115 can generate long-term characteristics from output generated by the sequence processing layer 110. Each layer is described in turn.

The static enrichment layer 250 enhances temporal characteristics received from the sequence-to-sequence layer 220 with context vectors that the system 100 generates using the static covariate encoder 235. Enriching the temporal characteristics can be important as static covariates have a significant influence on temporal data, e.g., genetic information for a patient (which is generally static through each time-step) has an important bearing on disease risk for the patient at different forecasting horizons.

Rather than dismiss or make generalizing assumptions about these static variables, the system 100 can instead integrate the static covariates 125, and then gate their relative contribution to the temporal characteristics generated by the sequence processing layer 110 using a plurality of gating mechanisms referred to in this specification as Gated Residual Networks (GRNs) 250A-N. In general, the system 100 is configured to learn a set of shared weights for each GRN 250A-N to promote certain characteristics processed by the sequence processing layer 110 as more or less “relevant” at a given time-step. Relevancy can be measured, for example, based on a statistical correlation between the presence, absence, or value of a certain temporal characteristic at a given time-step, and the value of a predicted forecast that the system 100 generated using the given time-step.

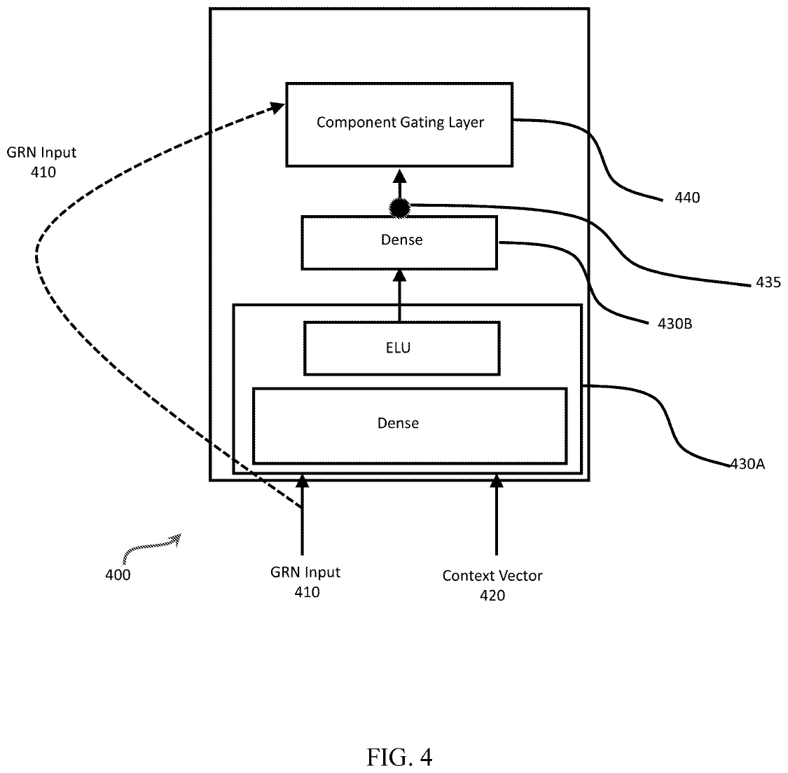

FIG. 4 shows an example of a Gated Residual Network (GRN) 400. The GRN 400 is used in the system 100 to adapt input processing for heterogeneous time-series data. In other words, the system 100 through GRNs and other gating mechanisms can adjust the processing flow of input to predicted forecasts, based on the presence or absence of certain inputs at different time-steps, or learned importance of those certain inputs to the predicted forecasts. Because the precise relationship between inputs and targets is not always known in advance, it can be difficult to determine what is relevant in the input. Another problem is the relative size or noisiness of processed time-series data. For small or noisy time-series data, less architecturally complex models may perform with higher accuracy than others. Therefore, to resolve these problems, the system can implement a gating mechanism such as the gated residual network 400.

GRNs can be implemented in a plurality of locations logically within the system 100. For instance, and as shown in FIG. 2, the static enrichment layer 250 can implement a plurality of GRNs 250A-N. The system 100 can implement the GRNs 250A-N for each time-step in the time-window in the range [−k, τ_{MAX}], or any subset of the time-steps thereof. For a GRN input α 410 and context vector c 420, the GRN 400 can be defined as:

GRN_{ω}=LayerNorm(α+GLU_{ω}(η₁))

η₁=W_{1,ω}η₂+b_{1,ω},

η₂=ELU(W_{2,ω}+W_{3,ω}c+b_{2,ω}),

where η₁/η₂ are dense layers 430A-B; w is an index to denote weight sharing among other GRNs implemented by the system 100; W_{j,ω} refers to the weights in the jth row corresponding to the jth layer of the GRN 400; b_{j,ω} refers to the value of the bias at the jth layer; and LayerNorm(α+GLU_{ω}(η₁)) is a component gating layer 440 with layer normalization. In some implementations, the system 100 is configured to learn separate model parameter values, i.e., weights and biases, for each GRN 250A-N according to input for different time-steps, or different types of time-dependent input, i.e., observational or known. Note that the GRN input α 410 is input at two parts of the GRN 400: once for the dense layer 430A and again for the component gating layer 440. This allows the GRN 400 to function as an identity function in some cases by outputting the GRN input α410 added by a zero or near-zero output for the GLU in the component gating layer 440.

The dense layer 430A includes an ELU, which maps inputs to outputs such that when W_{2,ω}α+W_{3,ω}c b_{2,ω}<<0, the ELU generates a constant output, resulting in linear layer behavior. Although the ELU is described, other activation functions can be used.

To provide at least some of the flexibility to suppress parts of the system 100 that are not required for processing a given input 105, the GRN 400 can include the component gating layer 440. For example, the component gating layer 440 can implement a GLU, which can be defined as:

GLU_{ω}(γ)=σ(W_{4,ω}+b_{4,ω}⊙W_{5,ω}γ+b_{5,ω})

where σ is the sigmoid activation function; W and b are the weights and biases for the GLU; and ⊙ is the Hadamard (or element-wise) product operator.

Although the sigmoid activation function is used, in some implementations other non-linear functions can be substituted. The GLU allows the component gating layer 440 to control the extent in which the GRN 400 contributes to the GRN input 410, potentially skipping over the layer entirely if necessary. For example, if the GLU outputs are all close to 0, the GRN can suppress the (negligible) non-linear contribution of the GRN input 410. For instances without a context vector, the GRN treats the context input as zero or any constant value. During training, dropout can be applied before gating and normalization, e.g., to the dense layer η₁ 430B.

The static enrichment layer 250 can take the following form:

θ(t,n)=GRN_{θ}((\tilde{ϕ}(t,n),cₑ)

where the weights θ are shared across the GRNs 250A-N and where each GRN 250A-N receives, as input, temporal characteristics \tilde{ϕ}(t, n) from the sequence processing layer 110 at time-step n, and a context vector cₑ generated by the static covariate encoder 235. Note that between the attention processing layer 115 and the sequence processing layer 110, the static covariate encoder 235 generates at least three context vectors: c_{c} (for the initial cell of the encoder 222); cₕ (for the hidden state of the encoder 222 at the first time-step t−k); and cₑ (for the static enrichment layer 250).

Following the static enrichment layer 250, the system 100 processes the enriched temporal characteristics from the sequence processing layer 110 through the temporal self-attention layer 260. The system applies the enriched temporal characteristics from the static enrichment layer 250 through an interpretable multi-head multi-head attention layer 262.

The interpretable multi-head multi-head attention layer 262 is a mechanism by which the system 100 learns long-term relationships between variables represented at different time-steps. The multi-head attention layer 262 as described in this specification can allow for greater interpretability of forecasts generated by the system 100. In general, attention mechanisms scale values V based on relationships between keys K and queries Q, as below:

Attention(Q,K,V)=A(Q,K)V

where A(⋅) is a normalization function. One option for A(⋅) is to use scaled dot-product attention, but other functions can be used.

The multi-head attention layer 262 can be implemented as a multi-head attention mechanism, in which different “heads” attend to different subspaces within (Q, K, V) according to different weight values. In some cases, this can improve learning capacity over single-head attention mechanisms. A multi-head mechanism can be given as:

MultiHead(Q,K,V)=[H₁, . . . ,Hₘ]

Hₕ=Attention(QW_{q}^{h},KW_{K}^{h},VW_{V}^{h}),

where Q W_{q}^{h}, K W_{K}^{h}, V W_{V}^{h} are head-specific weights for keys, queries, and values, respectively.

However, one problem with multi-head attention mechanisms is that attention weights alone may not be indicative of a particular characteristic's importance, at least because different values are used in each head. Therefore, the multi-head attention layer 262 can instead share weight values among each head, and also additively aggregate the heads, which can be given by:

$$InterpretableMultiHead ( Q , K , V ) = \tilde{H} {W}_{H}$$

$$\tilde{H} = \tilde{A} ( Q , K ) V {W}_{V} ,$$

$$= \{ \frac{1}{H} {\sum }_{h = 1}^{{m}_{H}} A ( Q {W}_{Q}^{h} , K {W}_{K}^{h} ) \} V {W}_{v} ,$$

$$= \frac{1}{H} {\sum }_{h = 1}^{{m}_{H}} Attention ( Q , {W}_{Q}^{h} , K {W}_{K}^{h} , V {W}_{V} )$$

where Wᵥ are value weights shared across all heads; W_{H} are weights used for final linear mapping; and m_{H} is the number of heads implemented.

The multi-head attention layer 262 can learn temporal patterns for subspaces attended to by each head [1 to m_{H}], while still attending to a common set of inputs, which can be interpreted as an ensemble over attention weights into a combined matrix A (Q, K). Therefore, the multi-head attention layer 262 can attend to the temporal characteristics to potentially improve accuracy as to a particular temporal characteristic's relevance because the characteristics can be processed in both a specific context, i.e., the subspace attended to by a particular head, and a global context, i.e., because multiple heads can learn together through shared weights.

Specifically, the multi-head attention layer 262 processes the enriched temporal characteristics, given by:

B(t)=InterpretableMultiHead(Θ(t),Θ(t),Θ(t))

where Θ(t) represents a matrix of all temporal characteristics within the time-window [−k, τ_{MAX}] and relative to a time-step t. B (t) yields:

[α(t,−k), . . . ,β(τ_{MAX})],d_{V}=dₐₜₜₙ=d_{model}/m_{H}

where d_{model} is the dimensionality of the multi-head attention layer 262, and m_{H} is the number of heads applied. In general, any number of heads can be applied, and the system 100 in some implementations can adaptively adjust the number of heads implemented in response to different criteria, e.g., the size of the time-window analyzed for a time-step t or the complexity of the temporal characteristics generated. Because self-attention is used, Θ(t) represents the value, query, and key. The multi-head attention layer 262 can also apply a decoder mask to limit each temporal dimension to attend only to characteristics preceding it, i.e., not to attend to characteristics for time-steps in the future. Masking the future characteristics can help to maintain causal relationships between characteristics of a current time-step and characteristics of preceding time-steps leading up to the current time-step. In addition, masking future temporal characteristics can also allow the system 100 to identify long-range dependencies that can be challenging for other forecasting systems.

In some implementations, the temporal self-attention layer 260 can also include a gating layer 264. The gating layer 264, similar to the gating layer 240, can filter or gate some temporal characteristics that are deemed by the system 100 to be not as relevant for generating one or more forecasts. In accordance with trained weights, the gating layer 240 can amplify or negate the contribution of different temporal characteristics during processing. In some cases, temporal characteristics that are not gated out by the gating layer 240 may be gated out later by the gating layer 264. For example, because after the system 100 processes the temporal characteristic through the multi-head attention layer 262, the temporal characteristic is found to be less relevant for forecasting. In one example, the gating layer 264 can be given by:

δ(t,n)=LayerNorm(Θ(t,n)+GLU_{δ}(β(t,n))

where Θ(t, n) represents the statically-enriched temporal characteristics; δ represents a set of weights for a gated linear unit implemented in the gating layer 264; and B (t, n) represents the attended temporal characteristics following processing through the multi-head attention layer 262.

The system 100 can process the output from the temporal self-attention layer 260 through the feed-forward layer 270. The feed-forward layer 270 can include GRNs 270A-N. As described above with reference to FIG. 2 and FIG. 4, the GRNs 270A-N can gate some temporal characteristics according to a learned set of weights. One example configuration of the feed-forward layer 270 can be:

ψ(t,n)=GRN_{ψ}(δ(t,n))

where ψ represents the weights for the GRNs 270A-N, and δ(t, n) is the output from the gating layer 264.

The system 100 can apply an additional gating layer 266 to optionally gate output from the remote processing layer 115 altogether. In this way, the system 100 can adapt to a more simple architecture depending on the input 105. For example, the input 105 may represent time-series data relatively close in time to one another, and the system 100 may be configured to generate forecasts at time-steps that are not far enough forward in time to warrant the additional complexity of the remote processing layer 115.

The gating layer 266 can be given by:

\tilde{ψ}(t,n)=LayerNorm(\tilde{ϕ}(t,n)+GLU_{\tilde{ψ}}(ψ(t,n))

where \tilde{ϕ}(t, n) represents the temporal characteristics processed through the gating layer 240; ψ(t, n) represents the temporal characteristics after processing through the temporal self-attention layer 260; and \tilde{ψ} represents a set of weights shared among the GLUs in the gating layer 266.

Following the gating layer 266 (in implementations in which it is implemented as part of the system 100), the system 100 can process the temporal features (after processing through the sequence processing layer 110, the remote processing layer 115, and any intervening layers that were not skipped by a gating layer) to obtain the forecasts 120 corresponding to the horizons of interest. The 50^{th}, system 100 can generate various percentiles, e.g., 10^{th}, 50^{th}, and 90^{th} percent) forecast ranges for each time-step of interest, by processing the output through a dense layer 268, given by:

ŷ(q,t,τ)=W_{q}\tilde{ψ}(t,τ)+b_{q}

where W, b are linear coefficients for the specified quantile q; \tilde{ψ}(t, n) is the output from the gating layer 266; and τ is a forecasting horizon.

FIG. 5 shows an example of a variable selector 500. As described above with reference to FIGS. 1 and 2, the system 100 can process the static covariates 125, the observational inputs 205 and the known inputs 210 through the static variable selector 230A and the variable selectors 230B-N, respectively. The variable selector 500 is an example of how the system 100 can implement each of the variable selectors 230A-N.

Through the variable selection layer 230, the system 100 is configured to provide instance-wise variable selection of both static covariates and time-dependent variables. Beyond providing insights into which variables are more significant for accurate forecasting, as described in more detail below with reference to FIGS. 6A-C, the system 100 can further process input through the variable selection layer 230 to remove unnecessary noise, which can potentially negatively impact performance. In addition, because the system 100 is configured to process heterogeneous sources of time-series data, the variable selection layer 230 allows the system 100 to robustly filter out unnecessary or less-relevant information that in turn can improve overall system performance in multi-horizon forecasting.

The variable selector 500 is configured to receive d^{model}-dimensional vectors of real values derived from the input, i.e., for each static covariate, observational input, and known input. As a pre-processing step, the system 100 can convert inputs with categorical values into entity embeddings, and linearly transform continuous variables to match the input format for the variable selector 500. In this specification, an embedding refers to a vector having numeric elements. In some implementations, the variable selector 500 is itself configured to transform received inputs to d^{model} dimensional vectors.

Without loss of generality, the variable selector 500 will be described as a selector configured to receive the observational inputs 205. Let ξ^{(j)} represent the jth input for a given time-step t, with Ξₜ=[ξ⁽⁰⁾^{^{T}}, . . . ξ^{(m}^{_{χ}}⁾^{^{T}}]^{T} being the flattened vector of all past observational inputs at time t. The variable selector 500 processes both the vector Ξₜ and an external context vector c_{S} through a gating layer 505 that includes a Gated Residual Network, followed by a Softmax layer, defined as:

v_{χt}=Softmax(GRNᵥ_{_{χ}}(Ξ,C_{S}))

where v_{χt}∈R^{m}^{_{χ}} is a vector of variable selection weights, and C_{S} is a context vector generated by the static covariate encoder 235. At each time-step, the variable selector 500 additionally processes each transformed vector through a separate GRN 510A-N, given by:

[symbol]

=GRN_{ξ}_{^{(j)}}(ξₜ^{j}),

where [symbol] represents input corresponding to a variable j (which itself may be part of an observational input or known input); and ξ^{(j)} represents the weights across all GRNs 510A-N. Notably, while some GRNs receive observational input (before time-step t) and others receive known input (after time-step t), the GRNs 510A-N can use the same set of shared weights for a given variable j.

The observational and known input processed through the GRNs 510A-N are weighted 520 by the weights generated by the gating layer 505, yielding:

[symbol]

=Σⱼ₌₁^{m}^{_{χ}}v_{χt}^{j}

[symbol]

where v_{χt}^{j} is the j-th element of v_{χt}.

The static variable selector 230A itself does not receive the context vector c_{S} separately as input, as the information is made available through the static covariates 125 themselves. By receiving the context vector c_{S}, the variable selector 500 can condition learned long- and short-term temporal relationships through static covariates that are consistent across the analyzed time-series data.

As mentioned above, the techniques described in this specification can allow for improved interpretability of the relationship between time-series data and resultant forecasts generated by the system 100. Interpretability generally refers to identifying and understanding portions of the input data and how individual variables are patterned or inter-relate with each other. The system 100 can generate forecasts in an interpretable way, meaning that the system 100 can provide insight into the relative importance or un-importance of certain input variables, which can motivate different implementations of the system 100 that are better suited for time-series data having particular characteristics.

With new-found insight into the relationship of different input variables and their relationship with a resultant forecast, the system 100 can learn these relationships and update corresponding weight values for the various gating layers described in different implementations. As described above, the gating layers can allow for certain parts of the system 100 to be suppressed. For example the attention processing layer 115, in situations in which the input 105 is found to not be receptive to long-term temporal processing can be suppressed. The system 100 may do so because the relevant input variables or the relationship between relevant input variables are most pronounced when the system 100 identifies temporal characteristics in the short-term, and not the long-term. In addition, the variable selection layer 230 can also suppress or elevate different input variables under different use-cases or different types of time-series data.

The following describes three use-cases for interpretability of the performance of the system 100 as between inputs and corresponding forecasts: (1) examining the importance of each input variable in prediction, (2) visualizing temporal patterns, and (3) identifying any regimes or events that lead to significant change sin temporal dynamics. These use cases show that the system 100 can aggregate patterns across an entire time-series dataset—extracting generalizable insights about temporal characteristics.

FIG. 6A is a flowchart of an example of a process 600A for determining variable importance for forecasted time-series data. For convenience, the process 600A is described as performed by a system implemented on one or more computers, located in one or more locations, and programmed appropriately in accordance with this specification. For example, a multi-horizon forecasting system, e.g., the multi-horizon forecasting system 100 of FIGS. 1-2, appropriately configured, can perform the process 600A.

The system aggregates 610 the variable selection weights generated for each input variable. The system 100 determines 620 one or more percentiles of a sampling distribution associated with each of the input variables. For example, the system can aggregate selection weights across the entire test set of training data used to train the system 100, and record the 10^{th}, 50th, and 90^{th} percentiles of each sampling distribution. Because the system 100 in some implementations is configured to automatically process the input 105 through the variable selection layer 230, in those implementations the system 100 can also aggregate 610 the variable selection weights and determine 620 the sampling distribution associated with each of the input variables. In some implementations, the quantiles are mapped to a probability density function for further processing and analysis, e.g., by another system or by a user, of the output distribution of the system for the forecasted time-series data.

In addition or alternatively, the system 100 can obtain the weights of the multi-head attention layer 262 to determine variable importance for different input variables in relation to the remote processing layer 115. In some cases, understanding the importance of variables for determining long-term temporal characteristics can be just as or more important than variable selection weights from the variable selection layer 230 in the sequence processing layer 110. For example, long-term temporal characteristics may show persistent temporal patterns that are not available or less detectable if short-term temporal characteristics alone were interpreted.

FIG. 6B is a flowchart of an example of a process 600B for determining persistent temporal patterns for forecasted time-series data. For convenience, the process 600B is described as performed by a system implemented on one or more computers, located in one or more locations, and programmed appropriately in accordance with this specification. For example, a multi-horizon forecasting system, e.g., the multi-horizon forecasting system 100 of FIGS. 1-2, appropriately configured, can perform the process 600B.

The system generates 630 an attention-weighted sum of lower level features at each of a plurality of time-periods. The lower level features can include refers processed representation from the output of the sequence processing layer 110 at each time step t, e.g., temporal characteristics generated by the sequence processing layer 110 or intermediate representations generated during processing of input at the sequence-to-sequence layer 220, weighted by self-attention weights for the time-step t an horizon T. Recall that the weights for the multi-head attention layer 262 can be given as Ã(Q, K), then self-attention weights for temporal characteristics generated by the sequence processing layer 110 at a given time-step t can be given as Ã(ϕ(t), ϕ(t)). Multi-head attention outputs at each forecasting horizon τ are given as β(t, τ). Therefore, the multi-head attention outputs for each forecasting horizon can be described as an attention-weight sum of lower level features:

β(t,τ)=Σₙ₌₋ₖ^{τ}^{_{MAX}}α(t,n,τ)\tilde{θ}(t,n)

where α(t, n, τ) is the (τ, n)-th element of Ã(ϕ(t), ϕ(t)) and \tilde{θ}(t, n) is a row of \tilde{Θ}(t)=Θ(t)Wᵥ (the temporal characteristics generated at the sequence processing layer 110). For each forecasting horizon τ, the importance of a previous time point n<τ can hence be determined by analyzing distributions of a (t, n, τ) across all time-steps and entities.

The system determines 640 distributions of the attention-weighted sum across the time-periods. The system can use the attention weight patterns to shed light on the most important past steps for producing a forecast for a particular horizon. In contrast to other techniques which rely on model-based specifications for seasonability and lag analysis (which may be inaccurate, particularly if hand-tuned based on anecdotal experience), the system 100 can learn temporal patterns from raw data. In doing so, the system 100 can be relied on for model improvements, for example by way of specific feature engineering or data collection.

The discretization of weights corresponding to the sequence processing layer 110 and the remote processing layer 115 can allow the system 100 to track parameter values bearing on short- and long-term temporal characteristics resulting in a given forecast with minimal additional processing. In other words, the weights corresponding to the remote dependency 115 (responsible for long-term temporal characteristics) are distinct from weights corresponding to the sequence processing layer 110 (responsible for short-term temporal characteristics).

In addition to identifying patterns, identifying sudden changes in those patterns can also be very useful, as temporary shifts can occur due to the presence of significant regimes or events. For instance, regime switching behavior has been widely documented in time-series data representing financial markets, which are often characterized by temporal patterns and deviations from those patterns.

FIG. 6C is a flowchart of an example of a process 600C for determining shifts in temporal behavior in time-series data. For convenience, the process 600C is described as performed by a system implemented on one or more computers, located in one or more locations, and programmed appropriately in accordance with this specification. For example, a multi-horizon forecasting system, e.g., the multi-horizon forecasting system 100 of FIGS. 1-2, appropriately configured, can perform the process 600C.

The system determines 650 an average attention pattern. For a given entity represented in the input to the system, the average attention pattern per forecasting horizon can be defined as:

$$\overline{α} ( n , τ ) = {\sum }_{t = 1}^{T} \frac{α ( t , j , τ )}{T}$$

where α(t, j, τ) represents the self-attention weights at a time-step t+j, j∈[−k, τ_{MAX}] for a horizon τ.

Then, the system can construct the average value of the self-attention weights of the multi-head multi-head attention layer 262 across the time-window represented by [−k, τ_{MAX}] and for a given forecasting horizon τ. The average value can be given as:

α̅(τ)=[α(−k,τ), . . . ,α(τ_{MAX},τ)],

The system identifies 660 changes in distance from the average attention pattern that satisfy a threshold value. In particular, the system identifies changes in distance among self-attention weight vectors in α̅(τ) across different time-steps of the time-window. Any appropriate technique for computing a distance between vectors can be used. In some implementations, the system calculates distances between the self-attention weight vectors according to:

κ(p,q)=\sqrt{1−ρ(p,q)}

where ρ(p, q)=Σⱼ\sqrt{pⱼqⱼ} is the Bhattacharya coefficient measuring the overlap between discrete distributions—with pⱼqⱼ being elements of probability vectors p, q, respectively. The system can receive the coefficient as input or approximate the input, e.g., by analyzing the overlap between α̅(τ) and α̅(t, τ) for a given time-step t.

For each entity, the system determines significant shifts in temporal dynamics by computing a distance between self-attention weight vectors at each point with the average pattern, given as the following (aggregated for all horizons):

$$dist ( t ) = {\sum }_{τ = 1}^{{τ}_{MAX}} \frac{κ ( \overline{α} ( τ ) , α ( t , τ ) )}{{τ}_{MAX}}$$

$$where α ( t , τ ) = [ α ( t , - k , τ ) , … , α ( t , {τ}_{MAX} , τ ) ] .$$

To mitigate noise caused by minor shifts not likely to represent a regime change or significant event, the system can discard dist(t) for time-step t if the distance does not meet a predetermined threshold. The system can receive the predetermined threshold as input or the system can generate the threshold. For example, the system can generate distances between self-attention weight vectors at different time-steps and correlate the distances to forecasts generated by the system. Then, the system can identify a threshold in which self-attention weight vectors having a distance meeting the threshold are statistically significant to the generated forecast. In this way, the system can identify deviations in attention patterns, particularly in time-series data with periods of high volatility of input variables for different time-periods.

The system 100 can be trained according to a variety of machine learning training techniques, for example using a model trainer configured to train the system 100. The system 100 can be trained according to a supervised learning technique on a training set of labeled time-series data. When some or all of the layers of the system 100 are implemented as neural networks, the model trainer can pass training input through the system 100 to obtain a forecast corresponding to the training input. The model trainer can compute a loss between the output forecast of system 100 with a ground-truth set of forecasts corresponding to the training input. Then, gradients with respect to the loss can be computed for all model parameter values, e.g., weights, described across the various layers of the system 100 and updated. In some implementations, some parts of the system 100, e.g., the sequence processing layer 110 and the attention processing layer 115 are trained independently of one another.

The model trainer can implement one of a variety of different loss functions for training the system 100. One example class of loss functions that can be used is a class of functions that minimize quantile loss, summed across the quantile outputs making up the forecasts 120.

The model trainer can train the system on a training dataset, by first partitioning the data into three parts—a training set for learning, a validation set for hyperparameter tuning, and a hold-out test set for performance evaluation. The model trainer can train the system 100 according to one or more hyperparameters. The model trainer can be part of the system 100, or be implemented on one or more computers in one or more locations in a location remote from the system 100. The model trainer can train the system offline before loading the system 100 into memory coupled to one or more computers implementing the system 100. In addition or alternatively, the model trainer can train the system 100 online, in which model parameter values are adjusted while the system 100 is in operation, which can provide for improved accuracy of the system 100 in response to live data.

The training set can include a plurality of static covariates, observational inputs, and known inputs over multiple time-steps. Each time-step or group of time-steps is labeled with a corresponding set of forecasts representing a ground-truth value for the system 100 to predict. The training set can include a variety of different numbers of entities, e.g., 41 to 130,000, represented in the time-series data. In addition, the number of training inputs for training by the model trainer can vary, e.g., between 100,000 and 500,000, although more or fewer numbers of inputs can be used.

In terms of network parameter values, some examples for the look-behind parameter k include 90, 168, and 252 time-steps. On the other hand, example look-forward parameter values τ_{MAX} can be 5, 24, and 30. In some implementations, the model trainer is configured to train the system 100 according to a batch learning technique. In those implementations, the mini-batch size can be 64-256, for example. In implementations in which dropout is used, example rates include 0.1-0.9. The state size for the sequence-to-sequence layer 220 can vary as well, e.g., 160-320. The number of heads in the interpretable multi-head multi-head attention layer 262 can be 2-4, for example, although in some implementations a single head can be used.

The model trainer is configured to allow for hyperparameter optimization, which can be done according to a variety of different techniques, e.g., random search. The model trainer is configured to train the system 100 according to a variety of learning rates, e.g., 0.0001-0.01. In some implementations in which the model trainer performs backpropagation as part of training the system, the corresponding gradients can also be normalized according to different factors, e.g., 0.01-100.

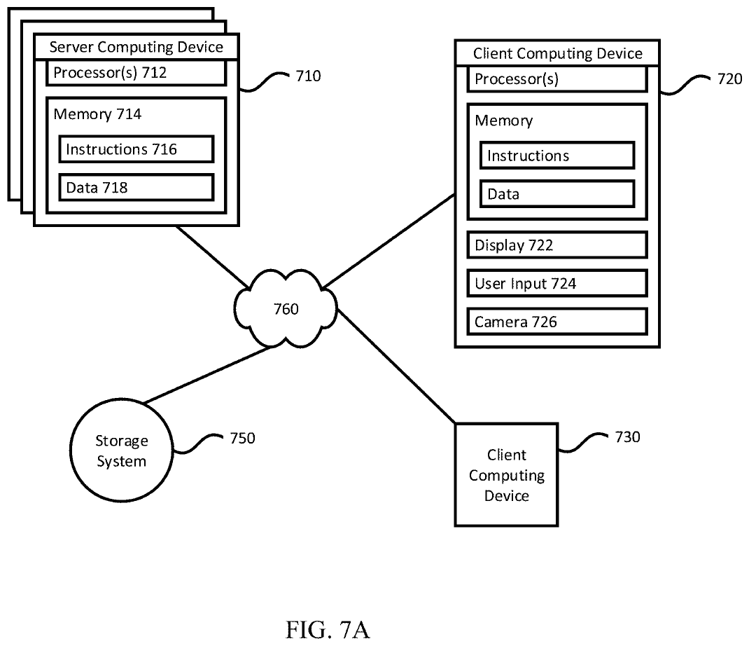

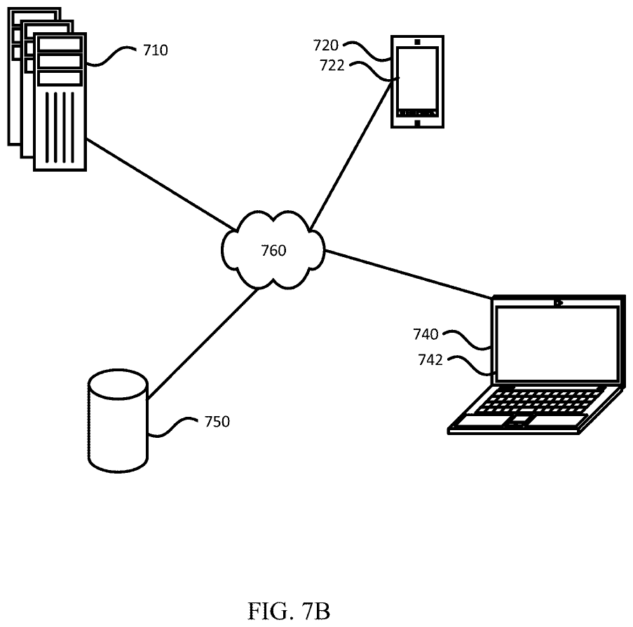

FIGS. 7A and 7B show an example of a multi-horizon forecasting system 700 implemented on or more computing devices. In this example, the system 700 can be implemented on one or more of computing devices 710, 720, 730 and 740 as well as on a storage system 750. The computing device 710 can contain one or more processors 712, memory 714 and other components typically present in general purpose computing devices. The memory 714 of the computing device 710 can store information accessible by the one or more processors 712, including instructions 716 that can be executed by the one or more processors 712 to cause the computing device 710 to perform operations for multi-horizon forecasting consistent with aspects of this disclosure.

Memory can also include data 718 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 716 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below. Example instructions may include a web application and/or feature applications.

The data 718 may be retrieved, stored or modified by the one or more processors 712 in accordance with the instructions 716. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can include any information sufficient to identify the relevant information, such as numbers, descriptive text, proprietary codes, pointers, references to data stored in other memories such as at other network locations, or information that is used by a function to calculate the relevant data.

The one or more processors 712 can be any conventional processors, such as a commercially available CPU. Alternatively, the processors can be dedicated components such as an application specific integrated circuit (“ASIC”) (including tensor processing units (“TPUs”)) or other hardware-based processor. Although not necessary, one or more of computing devices 710, 720, 730, and 740 may include specialized hardware components to perform specific computing processes, such as parallel processing. For instance, the one or more processors 712 can be graphics processing units 713 (“GPU”). Additionally, the one or more GPUs may be single instruction, multiple data (“SIMD”) devices and/or single instruction, multiple thread devices (“SIMT”).

Although FIG. 7A functionally illustrates the processor, memory, and other elements of computing device 710 as being within the same block, the processor, computer, computing device, or memory can actually include multiple processors, computers, computing devices, or memories that may or may not be stored within the same physical housing. For example, the memory can be a hard drive or other storage media located in housings different from that of the computing devices 710-740. Accordingly, references to a processor, computer, computing device, or memory will be understood to include references to a collection of processors, computers, computing devices, or memories that may or may not operate in parallel. For example, the computing devices 710-740 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 760.

Each of the computing devices 710 can be at different nodes of a network 760 and capable of directly and indirectly communicating with other nodes of network 760. Although only a few computing devices are depicted in FIGS. 7A-7B, it should be appreciated that a typical system can include a large number of connected computing devices, with each different computing device being at a different node of the network 760. The network 760 and intervening nodes described herein can be interconnected using various protocols and systems, such that the network 760 can be part of the Internet, World Wide Web, specific intranets, wide area networks, or local networks. The network can utilize standard communications protocols, such as Ethernet, Wi-Fi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, the computing device 710 may include web servers capable of communicating with storage system 750 as well as computing devices 720, 730, and 740 via the network. For example, one or more of server computing devices 710 may use network 760 to transmit and present information, web applications, etc., on a display, such as displays 722 of the computing device 720. In this regard, the computing devices 720, 730, and 740 may be considered client computing devices and may perform all or some of the features described herein.

Each of the client computing devices 720, 730, and 740 may be configured similarly to the server computing devices 710, with one or more processors, memory and instructions as described above. Each client computing device 720, 730, or 740 may be a personal computing device intended for use by a user, and have all of the components normally used in connection with a personal computing device such as a central processing unit (CPU), memory (e.g., RAM and internal hard drives) storing data and instructions, a display such as display 722 (e.g., a monitor having a screen, a touch-screen, a projector, a television, or other device that is operable to display information), and user input 724 (e.g., a mouse, keyboard, touchscreen, or microphone). The client computing device may also include a camera for recording video streams and/or capturing images, speakers, a network interface device, and all of the components used for connecting these elements to one another.

In this specification the phrase “configured to” is used in different contexts related to computer systems, hardware, or part of a computer program. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generates output according to the input and corresponding to the one or more operations. When a computer program is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system for multi-horizon forecasting comprising:
a sequence-to-sequence layer and a temporal self-attention layer for determining short- and long-term temporal characteristics for respective forecasting horizons of one or more time-steps, wherein:
the sequence-to-sequence layer is implemented by one or more computers, and configured to determine short-term temporal characteristics for the respective forecasting horizons of one or more time-steps, the sequence-to-sequence layer including:
one or more recurrent neural network (RNN) encoders for generating encoder vectors based on static covariates and time-varying input data captured during respective past time-periods, and
one or more RNN decoders, each RNN decoder configured to predict a short-term pattern for a respective future time period based on the encoder vectors, the static covariates, and time-varying known future input data; and
the temporal self-attention layer is implemented by the one or more computers and configured to capture long-term temporal characteristics for the respective forecasting horizons, the temporal self-attention layer including:
a multi-head attention layer configured to generate a forecast for each horizon based on the static covariates, the time-varying input data captured during the respective past time-periods, and the time-varying known future input data.

2. The system of claim 1, further comprising a variable selection layer, the variable selection layer configured to generate variable selection weights to each input variable including one or more of the static covariates, the time-varying input data captured during respective past time-periods, or the time-varying known future input data.

3. The system of claim 2, wherein the variable selection layer includes a plurality of variable selectors, with each variable selector of the plurality of variable selectors being configured to generate variable selection weights for the input variables at a respective future or past time period.

4. The system of claim 3, wherein the variable selection layer includes a variable selector configured to generate variable selection weights for a selection of the static covariates.

5. The system of claim 4, further comprising one or more static covariate encoders configured to encode context vectors based on the variable selection weights for the selection of the static covariates.

6. The system of claim 5, wherein the encoded context vectors are passed to each of the plurality of variable selectors in the variable selection layer.

7. The system of claim 6, wherein the encoded context vectors are passed to a static enrichment layer, the static enrichment layer including a plurality of gated residual networks (GRNs),
wherein each GRN is assigned a respective future or past time period and each GRN is configured to increase the weight of static covariates within the encoded context vectors that influence temporal dynamics corresponding to its respective time period.

8. The system of claim 7, wherein output of each GRN in the static enrichment layer forms a dataset inputted into the multi-head attention layer.

9. The system of claim 8, wherein the output of each GRN is input into a respective mask of the multi-head attention layer, wherein each mask corresponds to a respective time period for causal prediction.

10. The system of claim 1, wherein the forecast for each future time period is transformed into a quantile forecast.

11. The system of claim 1, further comprising a plurality of gating networks, wherein each gating network includes a plurality of gated linear units (GLUs) with shared weights.

12. The system of claim 11, wherein the plurality of GLUs are configured to reduce contributions of variables that have less effect on output prediction of the multi-horizon forecasting.

13. A method for multi-horizon forecasting comprising:
determining, by one or more computers executing a sequence-to-sequence layer and a temporal self-attention layer, short-term and long-term temporal characteristics for respective forecasting horizons of one or more time-steps, the determining including:
generating, using one or more recurrent neural network (RNN) encoders in the sequence-to-sequence layer, encoder vectors based on static covariates and time-varying input data captured during respective past time-periods, wherein static covariates are data that is constant across the time represented in the time-varying input data and in respective future time-periods, and
predicting, using one or more RNN decoders in the sequence-to-sequence layer, a short-term pattern for a respective future time period based on the encoder vectors, the static covariates, and time-varying known future input data; and
capturing, by the one or more computers implementing a temporal self-attention layer having a multi-head attention layer, long-term temporal characteristics for the respective forecasting horizons based on the static covariates, the time-varying input data captured during the respective past time-periods, and the time-varying known future input data.

14. The method of claim 13, further comprising:
generating, by a variable selection layer, variable selection weights to each input variable including one or more of the static covariates, the time-varying input data captured during respective past time-periods, or the time-varying known future input data.

15. The method of claim 14, wherein the variable selection layer includes a plurality of variable selectors, with each variable selector of the plurality of variable selectors being configured to generate variable selection weights for the input variables at a respective future or past time period.

16. The method of claim 14, wherein the variable selection layer includes a variable selector configured to generate variable selection weights for a selection of the static covariates.

17. The method of claim 14, further comprising:
encoding, by one or more static covariate encoders, context vectors based on the variable selection weights for the selection of the static covariates.

18. The method of claim 17, further comprising passing the encoded context vectors to each of the plurality of variable selectors in the variable selection layer.

19. The method of claim 18, further comprising passing the encoded context vectors to a static enrichment layer, wherein the static enrichment layer includes a plurality of gated residual networks (GRNs),
each GRN is assigned a respective future or past time period, and each GRN is configured to increase the weight of static covariates within the encoded context vectors that influence temporal dynamics corresponding to its respective time period.

20. One or more non-transitory computer-readable storage media storing instructions that are operable, when performed by one or more computers, to cause the one or more computers to perform operations comprising:
determining, by one or more first computers of the one or more computers executing a sequence-to-sequence layer and a temporal self-attention layer having a multi-head attention layer, short-term and long-term temporal characteristics for respective future time-periods, the determining including:
generating, using one or more recurrent neural network (RNN) encoders in the sequence-to-sequence layer, encoder vectors based on static covariates and time-varying input data captured during respective past time-periods, wherein static covariates are data that is constant across the time represented in the time-varying input data and in the respective future time-periods, and
predicting, using one or more RNN decoders in the sequence-to-sequence layer, a short-term pattern for a respective future time period based on the encoder vectors, the static covariates, and time-varying known future input data; and
capturing, by one or more second computers of the one or more computers implementing the temporal self-attention layer having a multi-head attention layer, long-term temporal characteristics for respective forecasting horizons based on the static covariates, the time-varying input data captured during the respective past time-periods, and the time-varying known future input data.
